(19) United States
(12) Patent Application Publication
(10) Pub. No.: US 2017/0140713 A1
(43) Pub. Date: May 18, 2017

(54) LIQUID CRYSTAL DISPLAY METHOD, DEVICE, AND STORAGE MEDIUM

(71) Applicant: Xiaomi Inc., Beijing (CN)

(72) Inventors: Anyu Liu, Beijing (CN); Lei Yu, Beijing (CN); Guosheng Li, Beijing (CN)

(73) Assignee: Xiaomi Inc., Beijing (CN)

(21) Appl. No.: 15/163,452

(22) Filed: May 24, 2016

(30) Foreign Application Priority Data
Nov. 12, 2015 (CN) 201510772756.2

(51) Int. Cl. G09G 3/36; G09G 3/20

(52) U.S. Cl. CPC G09G 3/36; G09G 3/2074; G09G 3/2018; G09G 2300/0452; G09G 2320/0252; G09G 2330/021

(57) ABSTRACT

Liquid crystal display methods and devices are disclosed. In one embodiment, a method comprises acquiring a grayscale value of each pixel in a first content displayed on a liquid crystal panel, and adjusting a refresh rate of the liquid crystal panel from a first refresh rate to a second refresh rate if the grayscale value of the each pixel in the first content is lower than a predetermined value, wherein the second refresh rate is lower than the first refresh rate. The method enables a reduction of power consumption of liquid crystal panel and associated display chip and processor.

### CROSS-REFERENCE TO RELATED APPLICATIONS

This application claims priority of the Chinese Patent Application No. 201510772756.2, filed on Nov. 12, 2015, which is incorporated herein by reference in its entirety.

### TECHNICAL FIELD

The present disclosure is related to a field of liquid crystal display, and more particularly, to a liquid crystal display having reduced power consumption.

### BACKGROUND

Since most terminals are powered by rechargeable batteries, it is very important to control their power consumptions.

At present, there are three major power consumers in a terminal: a liquid crystal panel, a display chip and a backlight. In the related arts, power consumption of terminals is reduced by decreasing power drained by their backlights.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Liquid crystal display methods and devices are disclosed for reducing power consumption. In one embodiment, a display method is disclosed, which comprises acquiring a grayscale value of each pixel in a first content displayed on a liquid crystal panel, and adjusting a refresh rate of the liquid crystal panel from a first refresh rate to a second refresh rate if the grayscale value of each pixel in the first content is lower than a predetermined value, wherein the second refresh rate is lower than the first refresh rate.

In another embodiment, a display device is discloses which comprises a processor, a display chip coupled to the processor, and a memory storing instructions executable by the processor, wherein the processor or the display chip, when executing the instructions, is configured to acquire a grayscale value of each pixel in a first content displayed on a liquid crystal panel, and adjust a refresh rate of the liquid crystal panel from a first refresh rate to a second refresh rate if the grayscale value of each pixel in the first content is lower than a predetermined value, wherein the second refresh rate is lower than the first refresh rate.

In yet another embodiment, a non-transitory computer-readable storage medium is having stored therein instructions is disclosed. The instructions, when executed by a processor of a mobile terminal, causes the mobile terminal to acquire a grayscale value of each pixel in a first content displayed on a liquid crystal panel, and adjust a refresh rate of the liquid crystal panel from a first refresh rate to a second refresh rate if the grayscale value of each pixel in the first content is lower than a predetermined value, wherein the second refresh rate is lower than the first refresh rate.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a schematic diagram showing a terminal according to the embodiments of the present disclosure;

FIG. 2 is a schematic diagram showing an arrangement of liquid crystal cells according to embodiments of the present disclosure;

FIG. 3 is a flow chart showing a liquid crystal display method according to an exemplary embodiment;

FIG. 4 is a flow chart showing a liquid crystal display method according to another exemplary embodiment;

FIG. 5 is a flow chart showing a liquid crystal display method according to yet another exemplary embodiment;

FIG. 6 is a flow chart showing a liquid crystal display method according to yet another exemplary embodiment;

FIG. 7 is a block diagram showing a liquid crystal display device according to an exemplary embodiment;

FIG. 8 is a block diagram showing a liquid crystal display device according to another exemplary embodiment;

FIG. 9 is a block diagram showing a liquid crystal display device according to yet another exemplary embodiment;

FIG. 10 is a block diagram showing a liquid crystal display device according to yet another exemplary embodiment; and

FIG. 11 is a block diagram showing a liquid crystal display device according to one exemplary embodiment.

### DETAILED DESCRIPTION

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

The methods, devices, and modules described herein may be implemented in many different ways and as hardware, software or in different combinations of hardware and software. For example, all or parts of the implementations may be a processing circuitry that includes an instruction processor, such as a central processing unit (CPU), microcontroller, a microprocessor; or application specific integrated circuits (ASICs), digital signal processors (DSPs), digital signal processing devices (DSPDs), programmable logic devices (PLDs), field programmable gate arrays (FPGAs), controllers, micro-controllers, microprocessors, other electronic components; or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Subject matter will now be described in more detail hereinafter with reference to the accompanying drawings in which the same numbers in different drawings represent the same or similar elements unless otherwise represented. The drawings form a part hereof, and show, by way of illustration, specific exemplary embodiments. Subject matter may, however, be embodied in a variety of different forms and, therefore, covered or claimed subject matter is intended to be construed as not being limited to any exemplary embodiments set forth herein. A reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

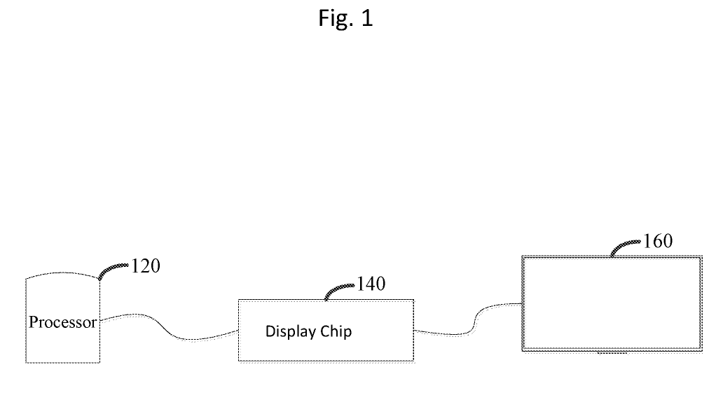

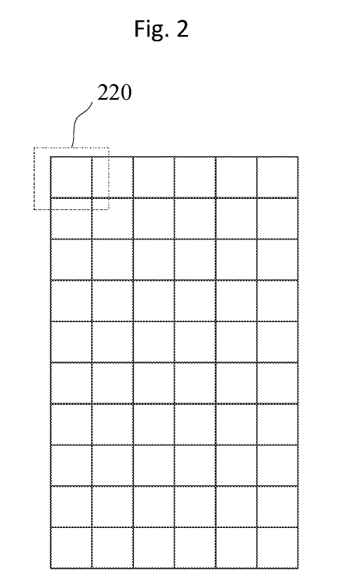

FIG. 1 is a schematic drawing showing a terminal according to embodiments of the present disclosure. The terminal comprises: a processor 120, a display chip 140, and a liquid crystal panel 160. The terminal may be but is not limited to a smart handset, a smart TV, a tablet PC, an ebook reader, an MP3 (Moving Picture Experts Group Audio Layer III) or MP4 (Moving Picture Experts Group Audio Layer IV) player, a laptop computer, a photo camera, or a video camera. The processor 120 may be but is not limited to a central processing unit, an application processor, or a graphic processor. The display chip 140 may as an example comprise a DDIC (Display Driver Integrated Circuit), and can control and drive contents displayed on the liquid crystal panel 160. The display chip may be an integrated circuit or, alternatively, may be implemented as discrete circuit components. The liquid crystal panel 160 can display contents under the control of the display chip 140, and may comprise m by n liquid crystal cells arranged as illustratively shown in FIG. 2, where one liquid crystal cell 220 stands for one pixel and is the smallest individually addressable unit of the liquid crystal panel. Here, m and n are integers. For example, m and n may be respectively 1080 and 720. They may alternatively be any other number suitable for displaying images. Each pixel may be further divided into subpixels for color rendering, as is well known in the art. Normally, the display chip 140 refreshes the liquid crystal panel 160 at a predetermined refresh rate of, e.g., 60 Hz. A content, as referred to herein, represents the image data for what is being displayed on the liquid crystal panel at a particular time. The liquid panel displays one content at a time. Contents are successively delivered to the display chip from the processor in the forms of a serials data stream specifying the pixel values of each content.

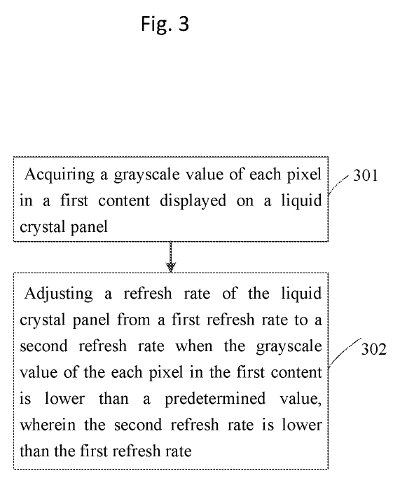

FIG. 3 is a flow chart showing a liquid crystal display method implemented in a terminal shown in FIG. 1 according to an exemplary embodiment. The method may comprise the following steps.

In step 301, the processor or the display chip acquires a grayscale value of each pixel in a first content displayed on a liquid crystal panel. The first content is a frame represented by the m×n liquid crystal cells in the liquid crystal panel 160, and comprises m×n pixels each having a grayscale value. For example, a grayscale value may be within an exemplary range of 0-255, where 0 corresponds to black and 255 corresponds to white. Calculation of the grayscale value for a colored pixel will be discussed in more detail below. The first content may be an image frame, a video frame, a user interface or the like.

In step 302, the processor or the display chip adjusts a refresh rate of the liquid crystal panel from a first refresh rate to a second refresh rate if the grayscale value of the each pixel in the first content is lower than a predetermined value. Here, the second refresh rate is lower than the first refresh rate. Since a pixel with very low grayscale value will be shown as (or almost as) black, the pixel's fresh rate can be decreased without degrading the perceived visual quality of the pixel. Therefore, if the grayscale value of the each pixel in the first content is lower than the predetermined value, the first content will be shown as (or almost as) black, hence the refresh rate of the entire liquid crystal panel may be decreased from a first refresh rate to a second refresh rate without sacrificing much visual quality. As an example, the first refresh rate may be a default rate of, e.g., 50 Hz, 60 Hz or 144 Hz, and the second refresh rate is a slower rate of, e.g., 1 Hz, 2 Hz or 5 Hz.

The liquid crystal display method provided in the embodiment of FIG. 3 acquires grayscale values of pixels in a first content displayed on a liquid crystal panel; and adjusts a refresh rate of the liquid crystal panel from a first refresh rate to a second refresh rate if the grayscale value of the each pixel in the first content is lower than a predetermined value, wherein the second refresh rate is lower than the first refresh rate. This enables a further reduction of power consumption of liquid crystal panel and display chip in terminals beyond power reduction approaches based on decreasing power drained by the backlight.

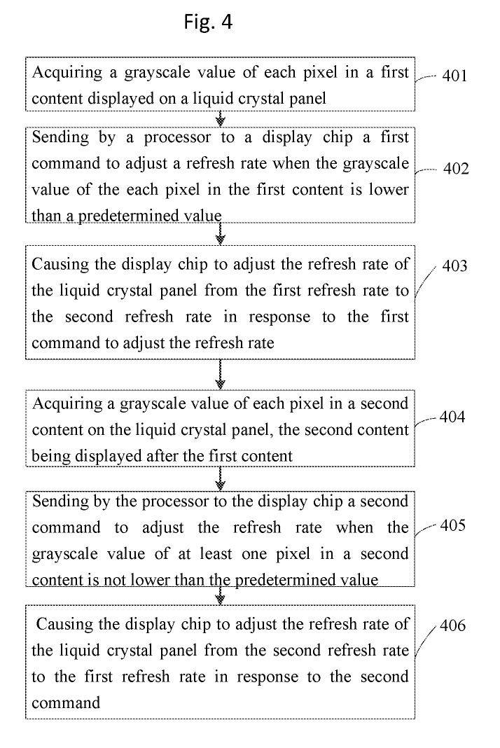

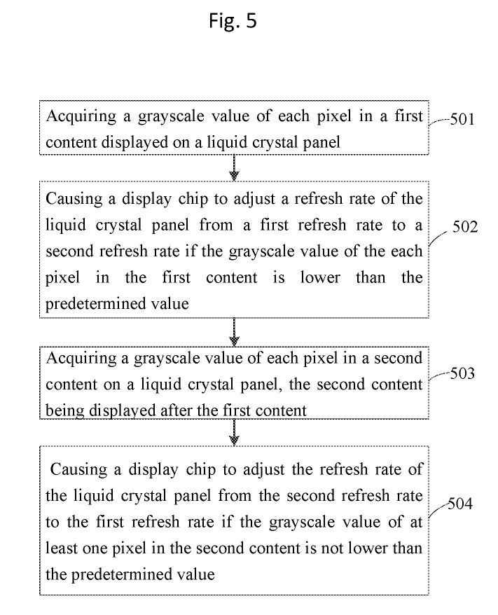

In the above embodiment, the step 301 and step 302 may be executed by a processor, which corresponds to the embodiment shown in FIG. 4. Alternatively, the step 301 and step 302 may be executed by a display chip, which corresponds to the embodiment shown in FIG. 5.

FIG. 4 is a flow chart showing a liquid crystal display method implemented in a terminal of FIG. 1 according to another exemplary embodiment. In step 401, the processor acquires a grayscale value of each pixel in a first content displayed on a liquid crystal panel. The first content displayed on the liquid crystal panel can comprise m×n pixels each including three subpixels of red, green and blue, wherein m and n are positive integers. For example, when the liquid crystal panel has an 8-bit color resolution, each of its subpixels will be assigned with one of 256 brightness levels, i.e. grayscale values. Since the color of a pixel is a combination of three subpixels of red, green or blue with various grayscale values, lower grayscale values will produce a darker pixel. Alternatively, the liquid crystal panel may also be a 10-bit panel or higher, where each subpixel of a pixel is assigned with more brightness levels.

The processor may acquire a grayscale value of each pixel in a first content displayed on a liquid crystal panel, wherein a grayscale value of each pixel comprises a set of grayscale values of red, green and blue components. Alternatively, the highest value Q among the grayscale values of the three components for each pixel may be chosen by the processor as the single-component grayscale value of the corresponding pixel.

The processor detects whether the grayscale value (either a three-component value, or a single-component value) of the each pixel in the first content is lower than the predetermined value (either a three-component value, or a single-component value). The predetermined value is a grayscale value corresponding to black or a color near to black, which can be, e.g., 0 or 5 for a single-component value, and (1,5,3) or (0,2,5) for a three-component value. The predetermined value may be any reasonable threshold preset and stored in the terminal or customized by a user, which will not be limited in this disclosure.

If the grayscale value of the each pixel in the first content is lower than the predetermined value, the processor will adjust a refresh rate of the liquid crystal panel from a first refresh rate to a second refresh rate, wherein the second refresh rate is lower than the first refresh rate. Specifically, in step 402, the processor sends to the display chip a refresh rate adjusting command upon determining that the grayscale value of the each pixel in the first content is lower than the predetermined value. In step 403, the processor causes the display chip to adjust the refresh rate of the liquid crystal panel from the first refresh rate to the second refresh rate in response to the refresh rate adjusting command.

Specifically, the first refresh rate may be a default or initial refresh rate of the liquid crystal panel. That is, the refresh rate of the liquid crystal panel when the displayed content is normally sent thereto by the display chip. For example, the first refresh rate may be 60 Hz. Upon receiving from the processor the refresh rate adjusting command, the display chip adjusts the refresh rate of the liquid crystal panel to a second refresh rate. That is, the display chip begins sending displayed content to the liquid crystal panel at the second refresh rate which is lower than the first refresh rate. For example, the second refresh rate is 1 Hz.

However, the refresh rate of the liquid crystal panel may be kept at the first refresh rate if the processor determines that the grayscale value of at least one pixel in the first content is not lower than a predetermined value.

When the display chip generates contents to be displayed at a frame rate slower than the refresh rate of the liquid crystal panel, the current refresh rate can still remain if the content in the current frame is identical to that of its previous frame, and no grayscale value of any pixel in the currently displayed content needs to be acquired repeatedly for determination again.

In step 404, the processor acquires a grayscale value of each pixel in a second content on the liquid crystal panel, the second content being displayed after the first content. The second content is also a frame represented by the m×n liquid crystal cells in the liquid crystal panel 160, and comprises m×n pixels. The processor acquires grayscale values of pixels in the second content in the same way as that of step 401, which will not be repeated herein.

The processor may then cause adjusting the refresh rate of the liquid crystal panel from the second refresh rate to the first refresh rate if the processor determines that the grayscale value of at least one pixel in the second content is not lower than the predetermined value. Specifically, in step 405, the processor send to the display chip a refresh rate adjusting command upon comparing the grayscale values of the pixels in the second content to the predetermined value and determines that the grayscale value of at least one pixel in a second content is not lower than the predetermined value. In step 406: the processor causes the display chip to adjust the refresh rate of the liquid crystal panel from the second refresh rate to the first refresh rate in response to the refresh rate adjusting command. However, the refresh rate of the liquid crystal panel can remain at the second refresh rate if the processor determines that all the grayscale values of said pixels in the second content are lower than the predetermined value.

It should be noted that the above “first” and “second” does not indicate anything particular other than distinguishing between any two frames displayed one after another on the liquid crystal panel.

Thus, in the liquid crystal display method provided in the embodiment of FIG. 4, the processor acquires grayscale values of pixels in a first content displayed on a liquid crystal panel; and causes the display chip to adjust the refresh rate of the liquid crystal panel from a first refresh rate to a second refresh rate if the grayscale value of the each pixel in the first content is lower than a predetermined value, wherein the second refresh rate is lower than the first refresh rate. This enables further reduction of power consumption of liquid crystal panel and display chip in terminals beyond that may be achieved by merely decreasing the power drained by the backlight.

In addition, the method provided in this embodiment ensure that the refresh rate of the liquid crystal panel is not decreased unless all the grayscale values of said pixels in the displayed content are lower than the predetermined value (that is, unless the brightness of the displayed content is very low). This enables the refresh rate to remain high or normal when the displayed content is bright. Thus method thus helps reduce energy consumed by the terminal without significantly degrading the expected visual quality.

FIG. 5 is a flow chart showing a liquid crystal display method implemented in a terminal according to yet another exemplary embodiment. In step 501, grayscale value of each pixel in a first content displayed on a liquid crystal panel is acquired. The first content displayed on the liquid crystal panel can comprise m×n pixels each including three subpixels of red, green and blue, wherein m and n are positive integers. For example, when the liquid crystal panel is an 8-bit panel, each of its subpixels will be assigned with 256 brightness levels, i.e. grayscale values. Since the color of a pixel is a combination of three subpixels of red, green or blue with various grayscale values, lower grayscale values will produce a darker pixel. Alternatively, the liquid crystal panel may also be a 10-bit panel or higher, where each subpixel of a pixel is assigned with more brightness levels.

A display chip rather than the processor may acquire grayscale value of each pixel in the first content displayed on a liquid crystal panel, wherein a grayscale value of each pixel comprises may be a three-component grayscale value of red, green and blue components. Alternatively, the highest value G among the grayscale values of the three components for each pixel is chosen by the display chip as a single-component grayscale value of the corresponding pixel.

The display chip detects if the grayscale value of the each pixel in the first content is lower than the predetermined value. The predetermined value is a grayscale value corresponding to black or a color near to black, which can be, e.g., 0 or 5 etc. The predetermined value may be any reasonable threshold preset on the terminal or customized by a user, which will not be limited in this disclosure.

In step 502, the display chip is caused to adjust the refresh rate of the liquid crystal panel from a first refresh rate to a second refresh rate if the grayscale value of the each pixel in the first content is lower than the predetermined value, wherein the second refresh rate is lower than the first refresh rate. The first refresh rate may be a default or initial refresh rate of the liquid crystal panel, i.e., the refresh rate of the liquid crystal panel when the displayed content is sent thereto by the display chip in normal situations. For example, the first refresh rate is 60 Hz.

By comparing the acquired grayscale values of pixels with the predetermined value, the display chip adjusts the refresh rate of the liquid crystal panel to a second refresh rate if the display chip determines that the grayscale value of each pixel is lower than the predetermined value. As a consequence, the display chip begins sending contents to be displayed to the liquid crystal panel at the second refresh rate which is lower than the first refresh rate. For example, the second refresh rate may be 1 Hz. Alternatively, the refresh rate of the liquid crystal panel can remain at the first refresh rate if the display chip determines that a grayscale value of at least one pixel among said pixels in the first content is not lower than the predetermined value.

It should be mentioned that, when the display chip is generating contents to be displayed at a frame rate slower than the refresh rate of the liquid crystal panel, the current refresh rate can still remain if the content in the current frame is identical to that of its previous frame, and no grayscale value of any pixel in the currently displayed content needs to be acquired repeatedly for determination again.

In step 503, grayscale value of each pixel in a second content on a liquid crystal panel to be displayed after the first content is obtained. The second content is also a frame represented by the m×n liquid crystal cells on the liquid crystal panel 160, and comprises m×n pixels. The display chip rather than the processor acquires the grayscale values of pixels in the second content in the same way as that of step 501, which will not be repeated herein.

In step 504, the display chip is caused to adjust a refresh rate of the liquid crystal panel from the second refresh rate to the first refresh rate if the grayscale value of at least one pixel in the second content is not lower than the predetermined value. Specifically, by comparing the grayscale values of pixels in the second content with the predetermined value, the display chip adjusts the refresh rate of the liquid crystal panel from the second refresh rate to the first refresh rate if the display chip determines that the grayscale value of at least one pixel is not lower than a predetermined value. Alternatively, the refresh rate of the liquid crystal panel can remain at the second refresh rate if the display chip determines that all the grayscale values of said pixels in the second content are lower than a predetermined value.

Again, it should be noted that the above “first” and “second” does not indicate anything particular other than distinguishing between any two frames displayed one after another on the liquid crystal panel.

Thus, the liquid crystal display method provided in embodiment of FIG. 5, the display chip acquires grayscale values of pixels in a first content to be displayed on the liquid crystal panel; and adjusts the refresh rate of the liquid crystal panel from a first refresh rate to a second refresh rate if the grayscale value of the each pixel in the first content is lower than a predetermined value, wherein the second refresh rate is lower than the first refresh rate. This enables further reduction of power consumption of the liquid crystal panel and display chip in terminals beyond that may be achieved by merely decreasing the power drained by the backlight.

The method provided in this embodiment ensure that the refresh rate of the liquid crystal panel is not decreased unless all the grayscale values of said pixels in the displayed content are lower than a predetermined value (that is, unless the brightness of the displayed content is very low). This enables the refresh rate to remain high or normal when the displayed content is bright. This method thus helps reduce energy consumed by the terminal without significantly degrading the expected visual quality.

In addition, the method provided in this embodiment may reduce processor payload by using the display chip to acquire grayscale values of the pixels and to adjust the refresh rate if the acquired grayscale values are determined by the display chip to be lower than a predetermined value.

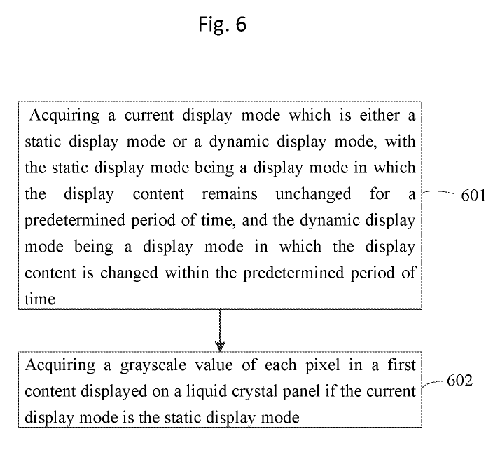

In alternative embodiments based on those shown in FIG. 4 and FIG. 5, other steps may be involved before the step 401 and step 501, as shown in FIG. 6. In step 601, the processor or the display chip acquires a current display mode which may be a static display mode or a dynamic display mode, with the static display mode being a display mode in which the display content remains unchanged for a predetermined period of time, and the dynamic display mode being a display mode in which the display content is changed within the predetermined period of time.

A currently displayed mode is determined by a display mode corresponding to the current content. Current display mode can be determined and obtained through various means. In one embodiment, a processor can acquire the current display mode by determining a currently displayed scene. A statically displayed scene with infrequent content change can be determined by the processor to be in a static display mode, while a dynamically displayed scene with frequent content change can be determined by the processor to be in dynamic display mode. For example, a video being played back can be determined by the processor to be in the dynamic display mode because frequently changing scenes are displayed, while a locked screen can be determined to be in a static display mode because non-varying scenes are displayed. Alternatively, a displayed scene can be pre-classified by a user as either a static scene or a dynamic scene. In another embodiment, a processor can acquire the current display mode by accessing the display frame buffer to detect if graphic data of a current frame and its adjacent frames are identical. The display mode can be determined as static if they are identical, or dynamic if they are different. Those of ordinary skill in the art understand that for video content, adjacent frames may be similar when the motion of the content of the frames is not substantial between neighboring frames. These scenes may still be classified as dynamic by comparing frames in the buffer that are predefined number of frames apart rather than adjacent.

The current display mode can be acquired by the processor through other means, and the predetermined period of time may be of any reasonable span preset on the terminal or customized by a user, and neither of which are limited by this disclosure. In one embodiment, the processor periodically determines the current display mode at an interval of T.

In step 602. The processor or the display chip acquires a grayscale value of each pixel in a first content displayed on a liquid crystal panel if the current display mode is the static display mode. Specifically, when it is determined that the current display mode is the static display mode, the processor deems the currently displayed first content to remain unchanged for a predetermined period of time, and begins acquiring a grayscale value of each pixel in the first content and then follow the possible refresh rate reduction steps of FIG. 4 or FIG. 5. Alternatively, the processor or the display chip may leave the refresh rate of the liquid crystal panel unchanged if it determines that the current display mode is a dynamic display mode.

In an exemplary embodiment, an electronic album is displayed on the terminal, with the first displayed content being an image frame. A displayed image content is periodically updated and replaced by a new one every 5 seconds, while the first refresh rate of the liquid crystal panel is 60 Hz. Assuming different image frames (or contents) are designated respectively as Frame1, Frame2, etc., and the first displayed content is Frame1. When a static display mode is determined, the processor begins acquiring a grayscale value of each pixel in the first content. Assuming the acquired grayscale values are all 0 and the predetermined value is 5, it can be determined that the first content is a black image, hence the refresh rate of the liquid crystal panel can be adjusted to a second refresh rate of 1 Hz, and the display chip begins refreshing the liquid crystal panel at a rate of one refresh per second. Accordingly, after the liquid crystal panel is refreshed for the first time (after 1 second), it is deemed that the currently displayed content is still the first content (which will last for 5 seconds), and the refresh rate will thus remain at the second refresh rate. The content displayed (the first content, Frame 1) is replaced with the second content (i.e. the Frame 2, which has different frame content with the first content) when the liquid crystal panel is refreshed for the fifth time (after 5 seconds), and the grayscale value for each pixel in the second content is acquired. Assuming that one of the acquired grayscale values of pixels in the second content is 10 which is higher than the predetermined value, the refresh rate of the liquid crystal panel will be adjusted to the first refresh rate.

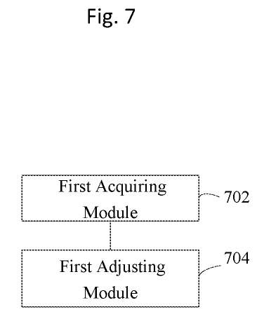

FIG. 7 is a block diagram showing a liquid crystal display device according to the exemplary embodiment of FIG. 1. The device comprises a first acquiring module 702 configured to acquire a grayscale value of each pixel in a first content displayed on the liquid crystal panel and a first adjusting module 704 configured to adjust a refresh rate of the liquid crystal panel from a first refresh rate to a second refresh rate if the grayscale value of the each pixel in the first content is lower than a predetermined value, wherein the second refresh rate is lower than the first refresh rate.

The liquid crystal display device provided in the embodiment of FIG. 7 acquires grayscale values of pixels in a content currently displayed on the liquid crystal panel, and adjusts the refresh rate of the liquid crystal panel from a first refresh rate to a second refresh rate if the grayscale value of the each pixel in the first content is lower than the predetermined value, wherein the second refresh rate is lower than the first refresh rate. This enables a further reduction of power consumption of liquid crystal panel and display chip in terminals beyond that may be achieved by merely decreasing the power drained by the backlight.

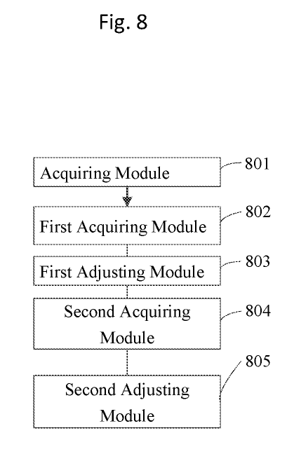

FIG. 8 is a block diagram showing a liquid crystal display device according to another exemplary embodiment of FIG. 1. The device of FIG. 8 comprises an acquiring module 801 configured to acquire a current display mode which is either a static display mode or a dynamic display mode, with the static display mode being a display mode in which the display content remains unchanged for a predetermined period of time, and the dynamic display mode being a display mode in which the display content is changed within the predetermined period of time. The device of FIG. 8 further comprises a first acquiring module 802 configured to acquire a grayscale value of each pixel in a first content displayed on a liquid crystal panel if the current display mode is the static display mode, and a first adjusting module 803 configured to adjust a refresh rate of the liquid crystal panel from a first refresh rate to a second refresh rate if the grayscale value of teach pixel in the first content is lower than the predetermined value, wherein the second refresh rate is lower than the first refresh rate.

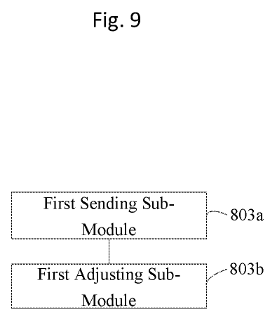

The first adjusting module 803 can be realized through any of two optional embodiments. In a first embodiment, the first adjusting module 803 is embodied by a processor and a display chip combined, and comprises a first sending sub-module 803a and a first adjusting sub-module 803b, as shown in FIG. 9. The first sending sub-module 803a is configured to cause the processor to send to the display chip a refresh rate adjusting command if all the grayscale values of pixels in the first content are lower than a predetermined value. The first adjusting sub-module 803b is configured to cause the display chip to adjust the refresh rate of the liquid crystal panel from the first refresh rate to the second refresh rate in response to the refresh rate adjusting command. In a second embodiment, the first adjusting module 803 may be embodied by a display chip alone, and is particularly configured to cause a display chip to adjust the refresh rate of the liquid crystal panel from a first refresh rate to a second refresh rate if the grayscale value of each pixel in the first content is lower than the predetermined value.

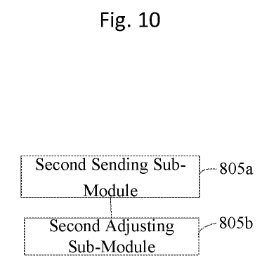

The device of FIG. 8 further comprises a second acquiring module 804 configured to acquire a grayscale value of each pixel in a second content on a liquid crystal panel, the second content being displayed after the first content, and a second adjusting module 805 configured to adjust the refresh rate of the liquid crystal panel from the second refresh rate to the first refresh rate if the grayscale value of at least one pixel in the second content is not lower than the predetermined value. The second adjusting module 805 may be realized through two alternative embodiments corresponding to the two embodiment of the first adjusting module 803 discussed above. Specifically, if the first adjusting module 803 is realized through the first embodiment discussed above for 803, the second adjusting module 805 will correspondingly be embodied by the processor and display chip combined, and comprises a second sending sub-module 805a and a second adjusting sub-module 805b, as shown in FIG. 10. The second sending sub-module 805a is configured to cause a processor to send to a display chip a refresh rate adjusting command if the grayscale value of at least one pixel in a second content is not lower than the predetermined value; and the second adjusting sub-module 805b is configured to cause the display chip to adjust the refresh rate of the liquid crystal panel from the second refresh rate to the first refresh rate in response to the refresh rate adjusting command. If the first adjusting module 803 is realized through said second embodiment, the second adjusting module will correspondingly be embodied by the display chip alone, and is particularly configured to cause the display chip to adjust the refresh rate of the liquid crystal panel from the second refresh rate to the first refresh rate if the grayscale value of at least one pixel in the second content is not lower than the predetermined value.

The liquid crystal display device provided in the embodiment of FIG. 8 thus acquires grayscale values of pixels in a content currently displayed on a liquid crystal panel, and adjusts a refresh rate of the liquid crystal panel from a first refresh rate to a second refresh rate if the grayscale value of the each pixel in the first content is lower than a predetermined value, wherein the second refresh rate is lower than the first refresh rate. This enables further reduction of power consumption of liquid crystal panel and display chip in terminals beyond that may be achieved by merely decreasing the power drained by the backlight. Additionally, the device provided in the embodiment of FIG. 8 may ensure that the refresh rate of the liquid crystal panel is not decreased unless all the grayscale values of said pixels in the displayed content are lower than a predetermined value (that is, unless the brightness of the displayed content is very low). This enables the refresh rate to remain high or normal when the displayed content is bright. This embodiment thus helps reduce energy consumed by the terminal without significantly degrading the expected visual quality.

With respect to the apparatus in the above embodiments, the specific manners for performing operations for individual modules therein have been described in detail in the related method embodiments. Those descriptions apply to the apparatus embodiments discussed above.

This disclosure further provides an exemplary embodiment of a liquid crystal display device for implementing the liquid crystal display method disclosed above, the device comprising: a processor; a display chip coupled to the processor; and a memory storing instructions executable by the processor. When executing the instructions, the processor or the display chip is configured to acquire a grayscale value of each pixel in a first content displayed on a liquid crystal panel and adjust the refresh rate of the liquid crystal panel from a first refresh rate to a second refresh rate if the grayscale value of the each pixel in the first content is lower than a predetermined value, wherein the second refresh rate is lower than the first refresh rate.

In one embodiment, when executing the instructions, the processor or the display chip is configured to cause the processor to send to the display chip a refresh rate adjusting command if the grayscale value of the each pixel in the first content is lower than the predetermined value and to cause the display chip to adjust the refresh rate of the liquid crystal panel from the first refresh rate to the second refresh rate in response to the refresh rate adjusting command.

In another embodiment, the processor or the display chip, when executing the instructions, is further configured to acquire a grayscale value of each pixel in a second content displayed on a liquid crystal panel and adjust the refresh rate of the liquid crystal panel from the second refresh rate to the first refresh rate if the grayscale value of at least one pixel in the second content is not lower than the predetermined value.

In another embodiment, the processor or the display chip, when executing the instructions, is configured to acquire a current display mode which is either a static display mode or a dynamic display mode, with the static display mode being a display mode in which the display content remains unchanged for a predetermined period of time, and the dynamic display mode being a display mode in which the display content is changed within the predetermined period of time, and to acquire the grayscale value of each pixel in a first content displayed on a liquid crystal panel if the current display mode is the static display mode.

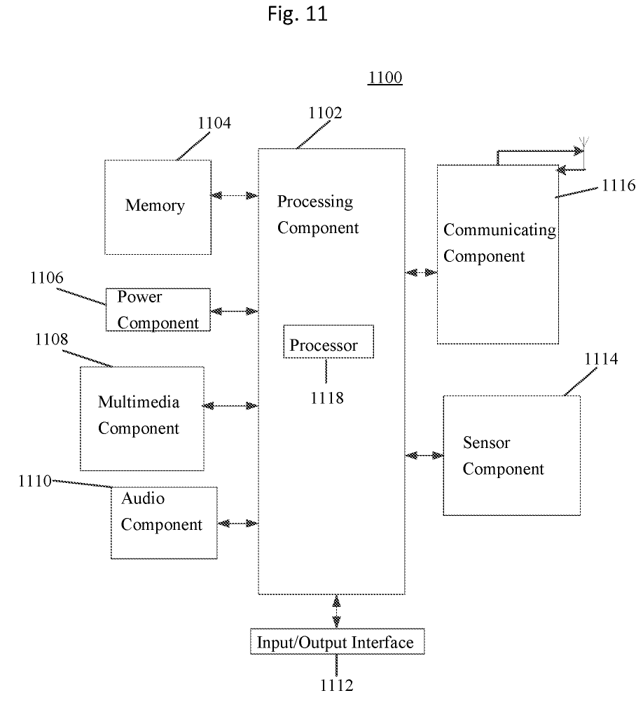

FIG. 11 is a block diagram showing a liquid crystal display device according to yet another exemplary embodiment. The device 1100 may be but is not limited to a mobile phone, a computer, a tablet, a medical device, an ebook reader, an MP3 or MP4 player, exercise equipment, or a personal digital assistant.

Referring to FIG. 11, the device 1100 may include one or more following components: a processing component 1102, a memory 1104, a power supply component 1106, a multimedia component 1108, an audio component 1110, an input/output (I/O) interface 1112, a sensor component 1114 and a communication component 1116.

The processing component 1102 generally controls the whole operations of the device 1100 such as display, phone call, data communication, camera operation and recording operation. The processing component 1102 may include one or more processors 1118 for executing instructions to perform all or part of the steps in the above described methods. Moreover, the processing component 1102 may include one or more modules for facilitating the interaction between the processing component 1102 and other components. For instance, the processing component 1102 may include a multimedia module to facilitate the interaction between the multimedia component 1108 and the processing component 1102.

The memory 1104 is configured to store various types of data to support the operation performed on the device 1100. Examples of such data include instructions for any applications or methods operated on the device 1100, contact data, phonebook data, messages, pictures, video, etc. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the device 1100. The power component 1106 may include a power management system, one or more power sources, and any other components associated with the generation, management, and distribution of power in the device 1100.

The multimedia component 1108 includes a display screen providing an output interface between the device 1100 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1108 includes one front-facing camera and/or one rear-facing camera. When the device 1100 is under an operation mode, for example, a shooting mode or a video mode, the front-facing camera and/or the rear-facing camera may receive outside multimedia information. Each of the front camera and the rear camera may be a fixed optical lens system or have variable focus and optical zoom capability.

The audio assembly 1110 is configured to output and/or input audio signal. For example, the audio component 1110 may include a microphone (“MIC”) configured to receive an external audio signal when the device 1100 is in an operation mode, such as a call mode, a recording mode, and a voice recognition mode. The received audio signal may be further stored in the memory 1104 or transmitted via the communication component 1116. In some embodiments, the audio component 1110 further comprises a speaker to output audio signals.

An I/O interface 1112 provides an interface between the processing component 1102 and a peripheral interface module. The above peripheral interface module may be a keyboard, a click wheel, and button, etc. The button may include but not limit to home page button, volume button, start button and lock button.

The sensor component 1114 includes one or more sensors and is configured to provide various assessments of the status of the device 1100. For instance, the sensor component 1114 may detect an open/closed status of the device 1100, relative positioning of components, e.g., the display and the keypad, of the device 1100, a change in position of the device 1100 or a component of the device 1100, a presence or absence of user contact with the device 1100, an orientation or an acceleration/deceleration of the device 1100, and a change in temperature of the device 1100. The sensor component 1114 may include a proximity sensor configured to detect the presence of nearby objects without any physical contact. The sensor component 1114 may also include an optical sensor (such as CMOS or a CCD image sensor) configured to be used in imaging application. In some embodiments, the sensor assembly 1114 may also include an accelerometer, a gyro sensor, a magnetic sensor, a pressure sensor or a thermometer.

The communication component 1116 is configured to facilitate wired or wireless communication between the device 1100 and other devices. The device 1100 may access the wireless network based on a communication standard, such as Wi-Fi, 2G, 3G, LTE, or 4G cellular technologies, or a combination thereof. In one exemplary embodiment, the communication component 1116 receives a broadcast information or broadcast associated information from an external broadcast management system via a broadcast channel. In one exemplary embodiment, the communication component 1116 may also include a Near Field Communication (NFC) module to facilitate short-range communication. For example, the NFC module may be based on Radio Frequency Identification (RFID) technology, Infrared Data Association (IrDA) technology, Ultra-Wideband (UWB) technology, Bluetooth (BT) technology and other technologies.

In an exemplary embodiment, the device 1100 may be realized through one or more among Application Specific Integrated Circuits (ASIC), a Digital Signal Processor (DSP), a Digital Signal Processing Device (DSPD), a Programmable Logic Device (PLD), a Field Programmable Gate Array (FPGA), a controller, a microcontroller, a microprocessor, or other electronic elements, and configured to carry out the liquid crystal display method described above.

In an exemplary embodiment, a non-transitory computer-readable storage medium comprising instructions is also provided. The instructions may be stored in memory medium 1104 of device 1100. The instructions may be carried out by the processor 1120 of the device 1100 to complete the liquid crystal display methods described above. The non-transitory computer-readable storage medium may be a ROM, a random access memory (RAM), a CD-ROM, a magnetic tape, a floppy disk, and an optical data storage device.

Each module or unit discussed above for FIG. 7-10, such as the first acquiring module, the first adjusting module, the acquiring module, the second acquiring module, the second adjusting module, the first sending sub-module, the first adjusting sub-module, the second sending sub-module, and the second adjusting sub-module, may take the form of a packaged functional hardware unit designed for use with other components, a portion of a program code (e.g., software or firmware) executable by the processor 1118 or the processing circuitry that usually performs a particular function of related functions, or a self-contained hardware or software component that interfaces with a larger system, for example.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments of the disclosure will be apparent to those skilled in the art from consideration of the specification and practice of the embodiments disclosed herein. This application is intended to cover any variations, uses, or adaptations of the disclosure following the general principles thereof and including such departures from the present disclosure as come within known or customary practice in the art. It is intended that the specification and examples are considered as exemplary only, with a true scope and spirit of the invention being indicated by the following claims in addition to the disclosure.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A display method, comprising:
acquiring a grayscale value of each pixel in a first content displayed on a liquid crystal panel; and
adjusting a refresh rate of the liquid crystal panel from a first refresh rate to a second refresh rate when the grayscale value of each pixel in the first content is lower than a predetermined value, wherein the second refresh rate is lower than the first refresh rate.

2. The method according to claim 1, wherein adjusting the refresh rate of the liquid crystal panel from the first refresh rate to the second refresh rate when the grayscale value of the each pixel in the first content is lower than a predetermined value comprises:
sending by a processor to a display chip a command to adjust the refresh rate when the grayscale value of each pixel in the first content is lower than the predetermined value; and
causing the display chip to adjust the refresh rate of the liquid crystal panel from the first refresh rate to the second refresh rate in response to the command to adjust the refresh rate.

3. The method according to claim 1, wherein adjusting the refresh rate of the liquid crystal panel from the first refresh rate to the second refresh rate when the grayscale value of the each pixel in the first content is lower than a predetermined value comprises:
adjusting by a display chip the refresh rate of the liquid crystal panel from the first refresh rate to the second refresh rate when the grayscale value of the each pixel in the first content is lower than the predetermined value.

4. The method according to claim 1, further comprising:
acquiring a grayscale value of each pixel in a second content displayed on the liquid crystal panel, the second content being displayed after the first content; and
adjusting the refresh rate of the liquid crystal panel from the second refresh rate to the first refresh rate when the grayscale value of at least one pixel in the second content is not lower than the predetermined value.

5. The method according to claim 2, further comprising:
acquiring a grayscale value of each pixel in a second content displayed on the liquid crystal panel, the second content being displayed after the first content; and
adjusting the refresh rate of the liquid crystal panel from the second refresh rate to the first refresh rate when the grayscale value of at least one pixel in the second content is not lower than the predetermined value.

6. The method according to claim 3, further comprising:
acquiring a grayscale value of each pixel in a second content displayed on the liquid crystal panel, the second content being displayed after the first content; and
adjusting the refresh rate of the liquid crystal panel from the second refresh rate to the first refresh rate when the grayscale value of at least one pixel in the second content is not lower than the predetermined value.

7. The method according to claim 1, further comprising:
acquiring a current display mode which is either a static display mode or a dynamic display mode, wherein the static display mode is a display mode in which the display content remains unchanged for a predetermined period of time, and the dynamic display mode is a display mode in which the display content is changed within the predetermined period of time,
wherein acquiring the grayscale value of each pixel in the first content displayed on the liquid crystal panel is conditioned on the current display mode being the static display mode.

8. The method according to claim 2, further comprising:
acquiring a current display mode which is either a static display mode or a dynamic display mode, wherein the static display mode is a display mode in which the display content remains unchanged for a predetermined period of time, and the dynamic display mode is a display mode in which the display content is changed within the predetermined period of time,
wherein acquiring the grayscale value of each pixel in the first content displayed on the liquid crystal panel is conditioned on the current display mode being a static display mode.

9. The method according to claim 3, further comprising:
acquiring a current display mode which is either a static display mode or a dynamic display mode, wherein the static display mode is a display mode in which the display content remains unchanged for a predetermined period of time, and the dynamic display mode is a display mode in which the display content is changed within the predetermined period of time,
wherein acquiring the grayscale value of each pixel in the first content displayed on the liquid crystal panel is conditioned on the current display mode being a static display mode.

10. A display device, comprising:
a processor;
a display circuit coupled to the processor; and
a memory storing instructions executable by the processor,
wherein the processor or the display circuit, when executing the instructions, is configured to:
acquire a grayscale value of each pixel in a first content displayed on a liquid crystal panel; and
adjust a refresh rate of the liquid crystal panel from a first refresh rate to a second refresh rate when the grayscale value of each pixel in the first content is lower than a predetermined value, wherein the second refresh rate is lower than the first refresh rate.

11. The display device according to claim 10, wherein the processor, when executing the instructions to adjust the refresh rate, is configured to:
generate a command to adjust the refresh rate when the grayscale value of the each pixel in the first content is lower than the predetermined value;
send the command to the display circuit; and
cause the display circuit to adjust the refresh rate of the liquid crystal panel from the first refresh rate to the second refresh rate in response to the command to adjust the refresh rate.

12. The display device according to claim 10, wherein the display circuit, when executing the instructions to adjust the refresh rate, is configured to adjust the refresh rate of the liquid crystal panel from the first refresh rate to the second refresh rate when the grayscale value of the each pixel in the first content is lower than the predetermined value.

13. The display device according to claim 10, wherein the processor or the display circuit, when executing the instructions, is further configured to:
acquire a grayscale value of each pixel in a second content displayed on the liquid crystal panel, the second content being displayed after the first content; and
adjust the refresh rate of the liquid crystal panel from the second refresh rate to the first refresh rate when the grayscale value of at least one pixel in the second content is not lower than the predetermined value.

14. The display device according to claim 11, wherein the processor or the display circuit when executing the instructions, is further configured to:
acquire a grayscale value of each pixel in a second content displayed on the liquid crystal panel, the second content being displayed after the first content; and
adjust the refresh rate of the liquid crystal panel from the second refresh rate to the first refresh rate when the grayscale value of at least one pixel in the second content is not lower than the predetermined value.

15. The liquid crystal display device according to claim 12, wherein the processor or the display circuit, when executing the instructions, is further configured to:
acquire a grayscale value of each pixel in a second content displayed on the liquid crystal panel, the second content being displayed after the first content; and
adjust the refresh rate of the liquid crystal panel from the second refresh rate to the first refresh rate when the grayscale value of at least one pixel in the second content is not lower than the predetermined value.

16. The display device according to claim 10, wherein the processor or the display circuit, when executing the instructions, is further configured to:
acquire a current display mode which is either a static display mode or a dynamic display mode, wherein the static display mode is a display mode in which the display content remains unchanged for a predetermined period of time, and the dynamic display mode is a display mode in which the display content is changed within the predetermined period of time,
wherein acquiring the grayscale value of each pixel in the first content displayed on the liquid crystal panel is conditioned on the current display mode being the static display mode.

17. The display device according to claim 11, wherein the processor or the display circuit, when executing the instructions, is further configured to:
acquire a current display mode which is either a static display mode or a dynamic display mode, wherein the static display mode is a display mode in which the display content remains unchanged for a predetermined period of time, and the dynamic display mode is a display mode in which the display content is changed within the predetermined period of time,
wherein acquiring the grayscale value of each pixel in the first content displayed on the liquid crystal panel is conditioned on the current display mode being the static display mode.

18. The display device according to claim 12, wherein the processor or the display circuit, when executing the instructions, is further configured to:
acquire a current display mode which is either a static display mode or a dynamic display mode, wherein the static display mode is a display mode in which the display content remains unchanged for a predetermined period of time, and the dynamic display mode is a display mode in which the display content is changed within the predetermined period of time,
wherein acquiring the grayscale value of each pixel in the first content displayed on the liquid crystal panel is conditioned on the current display mode being the static display mode.

19. A non-transitory computer-readable storage medium having stored therein instructions that, when executed by a processor of a mobile terminal, causes the mobile terminal to:
acquire a grayscale value of each pixel in a first content displayed on a liquid crystal panel; and
adjust a refresh rate of the liquid crystal panel from a first refresh rate to a second refresh rate when the grayscale value of each pixel in the first content is lower than a predetermined value, wherein the second refresh rate is lower than the first refresh rate.
